(19) United States
(12) Patent Application Publication
(10) Pub. No.: US 2025/0309468 A1
(43) Pub. Date: Oct. 2, 2025

(54) METHOD OF MANUFACTURING SOLID-STATE BATTERY

(71) Applicant: HONDA MOTOR CO., LTD., Tokyo (JP)

(72) Inventors: Takashi TOYOSHIMA, Saitama (JP); Yohei NOJI, Saitama (JP); Kosei MIYATA, Saitama (JP)

(21) Appl. No.: 19/064,736

(22) Filed: Feb. 27, 2025

(30) Foreign Application Priority Data
Mar. 30, 2024 (JP) 2024-058324

(51) Int. Cl. H01M 50/403; H01M 10/0525; H01M 10/0587; H01M 50/457; H01M 50/491

(52) U.S. Cl. CPC H01M 50/403; H01M 10/0525; H01M 10/0587; H01M 50/457; H01M 50/491

(57) ABSTRACT

A method of manufacturing a solid-state battery that includes an electrode laminate in which a negative electrode layer, an intermediate layer, a solid electrolyte layer, and a positive electrode layer are laminated in this order, the intermediate layer including a first intermediate layer and a second intermediate layer, the method includes: a first step of press-bonding the negative electrode layer and the first intermediate layer, thereby obtaining a first intermediate layer-negative electrode layer laminate; a second step of press-bonding the first intermediate layer-negative electrode layer laminate and the second intermediate layer, thereby obtaining an intermediate layer-negative electrode layer laminate; and a third step of disposing and press-bonding a substance that constitutes the solid electrolyte layer onto a lamination surface of the intermediate layer of the intermediate layer-negative electrode layer laminate, thereby obtaining a solid electrolyte layer-intermediate layer-negative electrode layer laminate.

This application is based on and claims the benefit of priority from Japanese Patent Application No. 2024-058324, filed on 30 Mar. 2024, the content of which is incorporated herein by reference.

### BACKGROUND OF THE INVENTION

### Field of the Invention

The present invention relates to a method of manufacturing a solid-state battery.

### Related Art

In recent years, research and development of secondary batteries that contribute to energy efficiency has been carried out in order to ensure many people have access to affordable, reliable, sustainable, and advanced energy.

As such secondary batteries, solid-state batteries including lithium metal batteries, lithium-ion secondary batteries, etc. have been known, in which a solid electrolyte layer is interposed between a positive electrode layer and a negative electrode.

There are disclosed techniques relating to the solid-state batteries, and an example thereof is directed to an all-solid-state battery in which a plurality of composite carbon layers having different binder contents are interposed between a solid electrolyte membrane and a negative electrode, and a difference between generated voltages causes lithium to be precipitated in a direction in which the composite carbon layers are opposed to each other, thereby improving life characteristics of the all-solid-state battery (for example, see PCT International Publication No. WO 2023/219283).

Patent Document 1: PCT International Publication No. WO 2023/219283

### SUMMARY OF THE INVENTION

A layer (intermediate layer) provided between the above-described solid electrolyte layer and negative electrode is made of a material having a very small particle diameter. In addition, since the intermediate layer is made thin to satisfy a required condition, a pinhole may form in the intermediate layer. Such a pinhole in the intermediate layer may disadvantageously allow dendrites to form therein.

The present invention has been made in view of the above circumstances, and an object of the present invention is to provide a method of manufacturing a solid-state battery capable of reducing the likelihood of the formation of a pinhole in an intermediate layer.

A first aspect of the present invention is directed to a method of manufacturing a solid-state battery that includes an electrode laminate in which a negative electrode layer, an intermediate layer, a solid electrolyte layer, and a positive electrode layer are laminated in this order, the intermediate layer including a first intermediate layer and a second intermediate layer. The method includes: press-bonding the negative electrode layer and the first intermediate layer, thereby obtaining a first intermediate layer-negative electrode layer laminate; press-bonding the first intermediate layer-negative electrode layer laminate and the second intermediate layer, thereby obtaining an intermediate layer-negative electrode layer laminate; and disposing and press-bonding a substance that constitutes the solid electrolyte layer onto a lamination surface of the intermediate layer of the intermediate layer-negative electrode layer laminate, thereby obtaining a solid electrolyte layer-intermediate layer-negative electrode layer laminate.

The first aspect of the present invention provides a method of manufacturing a solid-state battery capable of reducing the likelihood of the formation of a pinhole in the intermediate layer.

According to a second aspect of the present invention, the method of the first aspect further includes pressing the second intermediate layer before the press-bonding the first intermediate layer-negative electrode layer laminate and the second intermediate layer, and a pressing pressure in the pressing the second intermediate layer is higher than a pressing pressure in the press-bonding the negative electrode layer and the first intermediate layer and a pressing pressure in the press-bonding the first intermediate layer-negative electrode layer laminate and the second intermediate layer.

According to the second aspect, the second intermediate layer is densified, whereby the likelihood of the formation of dendrites can be reduced.

According to a third aspect of the present invention, in the method of the first or second aspect, a pressing pressure in the disposing and press-bonding the substance that constitutes the solid electrolyte layer onto the lamination surface of the intermediate layer of the intermediate layer-negative electrode layer laminate is higher than a pressing pressure in the press-bonding the negative electrode layer and the first intermediate layer and a pressing pressure in the press-bonding the first intermediate layer-negative electrode layer laminate and the second intermediate layer.

The third aspect makes it possible to densify the solid electrolyte layer.

According to a fourth aspect of the present invention, the method of any one of the first to third aspects further includes press-bonding the solid electrolyte layer-intermediate layer-negative electrode layer laminate and a layer including at least the positive electrode layer, thereby obtaining an electrode laminate, and a pressing pressure in the press-bonding the solid electrolyte layer-intermediate layer-negative electrode layer laminate and the layer including at least the positive electrode layer is higher than a pressing pressure in the press-bonding the negative electrode layer and the first intermediate layer and a pressing pressure in the press-bonding the first intermediate layer-negative electrode layer laminate and the second intermediate layer.

According to the fourth aspect, the electrode laminate is obtained by suitably integrating the layers.

According to a fifth aspect of the present invention, in the method of the fourth aspect, the pressing pressure in the press-bonding the solid electrolyte layer-intermediate layer-negative electrode layer laminate and the layer including at least the positive electrode layer is lower than a pressing pressure in the disposing and press-bonding the substance that constitutes the solid electrolyte layer onto the lamination surface of the intermediate layer of the intermediate layer-negative electrode layer laminate.

According to the fifth aspect, the electrode laminate is obtained by suitably integrating the layers.

According to a sixth aspect of the present invention, the method of the fourth or fifth aspect further includes pressing the layer including at least the positive electrode layer before the press-bonding the solid electrolyte layer-intermediate layer-negative electrode layer laminate and the layer including at least the positive electrode layer, and a pressing pressure in the pressing the layer including the positive electrode layer is higher than the pressing pressure in the press-bonding the solid electrolyte layer-intermediate layer-negative electrode layer laminate and the layer including at least the positive electrode layer.

According to the sixth aspect, the positive electrode layer is densified, thereby enabling an increase in the battery capacity.

According to a seventh aspect of the present invention, in the method of any one of the fourth to sixth aspects, the solid electrolyte layer-intermediate layer-negative electrode layer laminate includes the solid electrolyte layer as a first solid electrolyte layer, and the press-bonding the solid electrolyte layer-intermediate layer-negative electrode layer laminate and the layer including at least the positive electrode layer includes: disposing a second solid electrolyte layer between the solid electrolyte layer-intermediate layer-negative electrode layer laminate and the layer including at least the positive electrode layer; and press-bonding the second solid electrolyte layer, the solid electrolyte layer-intermediate layer-negative electrode layer laminate, and the layer including at least the positive electrode layer, thereby obtaining an electrode laminate.

The seventh aspect makes it possible to improve the bondability between the intermediate layer and the solid electrolyte layer.

An eighth aspect of the present invention, in the method of the seventh aspect, the press-bonding the solid electrolyte layer-intermediate layer-negative electrode layer laminate and the layer including at least the positive electrode layer includes press-bonding the solid electrolyte layer-intermediate layer-negative electrode layer laminate including the solid electrolyte layer as the first solid electrolyte layer, and a solid electrolyte layer-positive electrode layer laminate including the positive electrode layer and a third solid electrolyte layer, thereby obtaining an electrode laminate.

The eighth aspect makes it possible to improve the bondability between the intermediate layer and the solid electrolyte layer.

According to a ninth aspect of the present invention, in the method according to any one of the first to eighth aspects, the layers are press-bonded such that the second intermediate layer has a porosity of 40% to 45%.

According to the ninth aspect, the second intermediate layer is densified, whereby the likelihood of the formation of dendrites can be reduced.

According to a tenth aspect of the present invention, in the method according to any one of the first to ninth aspects, the layers are press-bonded such that the first intermediate layer has a porosity equal to or greater than that of the second intermediate layer, and the porosity of the first intermediate layer is less than 50%.

According to the tenth aspect, a void in the second intermediate layer is easily filled with the first intermediate layer, whereby the likelihood of a pinhole penetrating through the entire intermediate layer can be reduced.

According to an eleventh aspect of the present invention, in the method of any of the first to tenth aspects, a pressing pressure in the press-bonding the negative electrode layer and the first intermediate layer is 300 MPa or greater, a pressing pressure in the press-bonding the first intermediate layer-negative electrode layer laminate and the second intermediate layer is 300 MPa or greater and 600 MPa or less, and a pressing pressure in the disposing and press-bonding the substance that constitutes the solid electrolyte layer onto the lamination surface of the intermediate layer of the intermediate layer-negative electrode layer laminate is 500 MPa or greater and 800 MPa or less.

The eleventh aspect makes it possible to obtain an electrode laminate including the suitably configured layers, while reducing the likelihood of the formation of a pinhole in the intermediate layer.

According to a twelfth aspect of the present invention, in the method of the second aspect, the pressing pressure in the pressing the second intermediate layer is 600 MPa or greater and 1200 MPa or less.

According to the twelfth aspect, the second intermediate layer is densified, whereby the likelihood of the formation of dendrites can be reduced.

According to a thirteenth aspect of the present invention, in the method of the fourth aspect, the pressing pressure in the press-bonding the solid electrolyte layer-intermediate layer-negative electrode layer laminate and the layer including at least the positive electrode layer is 500 MPa or greater and 900 MPa or less.

According to the thirteenth aspect, the electrode laminate is obtained by suitably integrating the layers.

According to a fourteenth aspect of the present invention, in the method of the second aspect, the pressing the second intermediate layer is performed at room temperature or higher and 100° C. or lower.

According to the fourteenth aspect, the second intermediate layer is densified, whereby the likelihood of the formation of dendrites can be reduced.

### BRIEF DESCRIPTION OF THE DRAWINGS

FIG. 1 is a conceptual cross-sectional view illustrating a configuration of a solid-state battery according to an embodiment of the present invention;

FIG. 2A is a diagram illustrating a part of steps of a method of manufacturing a solid-state battery according to the embodiment of the present invention;

FIG. 2B is a diagram illustrating a part of the steps of the method of manufacturing a solid-state battery according to the embodiment of the present invention;

FIG. 2C is a diagram illustrating a part of the steps of the method of manufacturing a solid-state battery according to the embodiment of the present invention;

FIG. 2D is a diagram illustrating a part of the steps of the method of manufacturing a solid-state battery according to the embodiment of the present invention;

FIG. 2E is a diagram illustrating a part of the steps of the method of manufacturing a solid-state battery according to the embodiment of the present invention; and

FIG. 2F is a diagram illustrating a part of the steps of the method of manufacturing a solid-state battery according to the embodiment of the present invention.

### DETAILED DESCRIPTION OF THE INVENTION

### Solid-State Battery

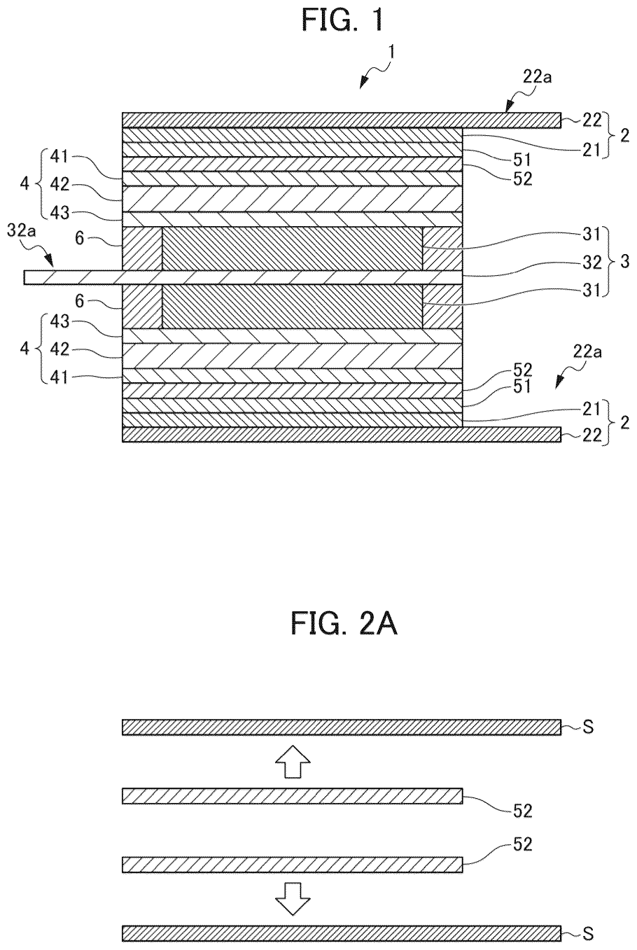

As illustrated in FIG. 1, a solid-state battery 1 manufactured by a manufacturing method according to an embodiment of the present invention includes an electrode laminate in which a negative electrode layer 2, an intermediate layer (including a first intermediate layer 51 and a second intermediate layer 52), a solid electrolyte layer 4, and a positive electrode layer 3 are laminated in this order. In the description of the present embodiment, the structure illustrated in FIG. 1, in which the negative electrode layer 2, the first intermediate layer 51, the second intermediate layer 52, the solid electrolyte layer 4, the positive electrode layer 3, the solid electrolyte layer 4, the second intermediate layer 52, the first intermediate layer 51, and the negative electrode layer 2 are laminated in this order, will be referred to as a laminate structure of the solid-state battery 1. However, the structure of the solid-state battery 1 is not limited to the foregoing, and it is sufficient for the solid-state battery 1 to include a structure in which the negative electrode layer 2, the intermediate layer (including the first intermediate layer 51 and the second intermediate layer 52), the solid electrolyte layer 4, and the positive electrode layer 3 that are laminated in this order.

The solid-state battery 1 may be a solid-state lithium-ion secondary battery or a lithium metal secondary battery, without any particular limitation.

### Negative Electrode Layer

The negative electrode layer 2 includes a negative electrode active material layer 21 and a negative electrode current collector layer 22. The negative electrode active material layer 21 may be constituted by any material that can be used as a negative electrode active material of a solid-state battery, without any particular limitation. The negative electrode active material layer 21 is preferably a lithium metal layer containing lithium metal as the negative electrode active material. This is because the solid-state battery 1 according to the present invention is configured such that even if the negative electrode active material layer 21 is a hard metal, the negative electrode active material layer 21 can be in tight contact with the solid electrolyte layer 4 with high adhesiveness. The lithium metal includes a lithium alloy and the like in addition to lithium metal alone. The negative electrode active material layer 21 may include, in addition to the above, a silicon-based active material such as Si, a Si alloy, etc., a lithium transition metal oxide such as lithium titanate (Li₄Ti₅O₁₂), etc., a transition metal oxide such as TiO₂, Nb₂O₃, WO₃, etc., a metal sulfide, a metal nitride, a carbon material such as graphite, soft carbon, hard carbon, etc., metal indium, and the like.

The negative electrode active material layer 21 may contain, in addition to the above, a material that can be contained in a negative electrode active material layer of a solid-state battery. Examples of the material include a solid electrolyte, a conductive additive, a binder, etc. Examples of the solid electrolyte include the same solid electrolytes as those contained in the solid electrolyte layer 4, which will be described later. Examples of the conductive additive include carbon black, natural graphite, carbon fibers, carbon nanotubes, etc. Examples of the binder include a nitrile polymer, a polyester polymer, an acrylic acid polymer, a cellulose polymer, a styrene polymer, a styrene butadiene polymer, a vinyl acetate polymer, a urethane polymer, a fluoroethylene polymer, etc.

The negative electrode current collector layer 22 may include copper, nickel, stainless steel, or the like, without any particular limitation. Examples of the shape of the negative electrode current collector layer 22 include a foil shape, a plate shape, a mesh shape, a nonwoven fabric shape, a foamed shape, etc. A part of the negative electrode current collector layer 22 extends in a predetermined direction to form a negative electrode current collector tab 22a.

### Intermediate Layer

The intermediate layer is interposed between the negative electrode layer 2 and the solid electrolyte layer 4. The intermediate layer includes two layers, namely, the first intermediate layer 51 disposed toward the negative electrode layer 2 and the second intermediate layer 52 disposed toward the solid electrolyte layer 4. For example, in a case where the solid-state battery 1 is a lithium metal battery, the intermediate layer has a function of causing lithium metal to precipitate uniformly. Due to this function, the interface between the intermediate layer and the solid electrolyte layer 4 is stabilized. In a case where the solid-state battery 1 is a lithium metal secondary battery having an intermediate layer, the solid-state battery 1 may be an anode-free battery in which the negative electrode active material layer 21 does not exist at the time of the initial charge. In this case, a lithium metal layer as the negative electrode active material layer 21 is formed after the initial charge and discharge.

Each of the first intermediate layer 51 and the second intermediate layer 52 may be constituted by any substance, and examples thereof include a metal that can be alloyed with lithium, amorphous carbon, and the like. Examples of the metal that can be alloyed with lithium include tin (Sn), silicon (Si), zinc (Zn), magnesium (Mg), gold (Au), platinum (Pt), palladium (Pd), silver (Ag), aluminum (Al), bismuth (Bi), antimony (Sb), etc. The metal that can be alloyed with lithium may be nanoparticles. Examples of the amorphous carbon include carbon blacks such as acetylene black, furnace black, Ketjhen black, etc., coke, activated carbon, and the like. The amorphous carbon may be graphitizable carbon (soft carbon), or may be non-graphitizable carbon (hard carbon), CNT (carbon nanotube), fullerene, or graphene. The intermediate layer may contain a binder in addition to the above substances.

The substances constituting the first intermediate layer 51 and the second intermediate layer 52 preferably have a particle diameter (D50) of 5 nm to 300 nm. The particle diameter is preferably smaller than the particle size (D50) of the solid electrolyte material constituting the solid electrolyte layer 4, which will be described later.

Each of the first intermediate layer 51 and the second intermediate layer 52 may have any thickness, but the respective thickness is preferably 1 μm to 3 μm. Forming each intermediate layer as thin as possible allows the solid-state battery 1 to have low resistance.

In a case where one intermediate layer having the particle diameter and the thickness described above is provided, a pinhole is likely to form. Constituting the intermediate layer by two intermediate layers, i.e., the first intermediate layer 51 and the second intermediate layer 52 makes it possible to reduce the likelihood of a pinhole penetrating through the entirety of the intermediate layer. The second intermediate layer 52 is preferably more densified than the first intermediate layer 51. In other words, the second intermediate layer 52 preferably has a porosity equal to or less than that of the first intermediate layer 51. Thus, the densified second intermediate layer 52 can suitably reduce the likelihood of the formation of dendrites. The first intermediate layer 51 having a relatively low density improves bondability with the negative electrode layer 2. Furthermore, even when a pinhole forms in the densified second intermediate layer 52, part of the first intermediate layer 51 can come into the void. As a result, the risk that a pinhole penetrates through the entirety of the intermediate layer can be reduced, thereby reducing the likelihood of formation of dendrites in the pinhole. In order to obtain the above effect, as will be described later, it is preferable that the second intermediate layer 52 is pressed to be densified in advance, and thereafter, bonded to the first intermediate layer 51.

The porosity of the first intermediate layer 51 is preferably equal to or greater than the porosity of the second intermediate layer 52, and more preferably exceeds the porosity of the second intermediate layer 52. The porosity of the first intermediate layer 51 is preferably less than 50%, and more preferably 48% or more. The porosity of the second intermediate layer 52 is preferably 40% to 45%, and more preferably 42% to 44%. The porosities can be determined by observing cross sections of the first intermediate layer 51 and the second intermediate layer 52 using a SEM or the like.

The first intermediate layer 51 and the second intermediate layer 52 differ from each other only in density (porosity) due to, for example, different pressing pressures in the manufacturing process, and may be made of the same substances. This configuration can improve the bondability between the first intermediate layer 51 and the second intermediate layer 52.

### Solid Electrolyte Layer

The solid electrolyte layer 4 is formed between the second intermediate layer 52 and the positive electrode layer 3. In the present embodiment, the solid electrolyte layer 4 has a structure in which a first solid electrolyte layer 41 disposed toward the second intermediate layer 52, a second solid electrolyte layer 42, and a third solid electrolyte layer 43 disposed toward the positive electrode layer 3 are laminated in this order. The number of layers included in the solid electrolyte layer 4 is not limited to the above.

The first solid electrolyte layer 41 is disposed adjacent to the second intermediate layer 52. The first solid electrolyte layer 41 is densified in a process for press-bonding it, and brought into tight contact with the second intermediate layer 52. Since the first solid electrolyte layer 41 is densified and brought into tight contact with the second intermediate layer 52, occurrence of abnormal electrodeposition can be suppressed. In addition, preferable battery performance can be obtained.

The first solid electrolyte layer 41 may be constituted by any solid electrolyte material, provided that the material can be used as an electrolyte of a solid-state battery. Examples of the solid electrolyte material include an inorganic solid electrolyte such as a sulfide solid electrolyte material, an oxide solid electrolyte material, a halide solid electrolyte, a lithium-containing salt, etc. and a polymer solid electrolyte such as a polyethylene oxide, etc. One kind of the foregoing solid electrolyte materials may be used alone, or two or more kinds thereof may be used in combination.

The solid electrolyte material constituting the first solid electrolyte layer 41 is preferably in the form of particles. The solid electrolyte material constituting the first solid electrolyte layer 41 has a particle diameter (D50) of preferably 10 μm or less, more preferably 3 μm or less, still more preferably 1 μm or less, and most preferably 0.7 μm or less. This configuration facilitates densification of the first solid electrolyte layer 41.

The first solid electrolyte layer 41 may contain a material that can be used for a solid electrolyte layer of a solid-state battery, in addition to the solid electrolyte material. For example, the first solid electrolyte layer 41 may contain a binder. The binder for the first solid electrolyte layer 41 may be the same substance as the binder that can be contained in the negative electrode active material layer 21.

The second solid electrolyte layer 42 is disposed adjacent to the first solid electrolyte layer 41. The second solid electrolyte layer 42 may be constituted by any solid electrolyte material, and can be constituted by the same material as the solid electrolyte material constituting the first solid electrolyte layer 41.

Similarly to the first solid electrolyte layer 41, the second solid electrolyte layer 42 may contain a binder or the like in addition to the solid electrolyte material. The second solid electrolyte layer 42 may include a support. Examples of the support include a three-dimensional structure such as a mesh, a woven fabric, a nonwoven fabric, an embossed body, a punched body, an expanded body, a foamed body, etc. The second solid electrolyte layer 42 does not have to include the support.

The third solid electrolyte layer 43 is disposed toward the positive electrode layer. In the present embodiment, the third solid electrolyte layer 43 is disposed adjacent to a positive electrode active material layer 31 included in the positive electrode layer 3. The third solid electrolyte layer 43 is disposed adjacent to the second solid electrolyte layer 42. That is, in the present embodiment, the third solid electrolyte layer 43 is interposed between the positive electrode active material layer 31 and the second solid electrolyte layer 42.

The third solid electrolyte layer 43 may have the same configuration as the first solid electrolyte layer 41. The third solid electrolyte layer 43 is densified and brought into tight contact with the positive electrode active material layer 31, thereby preferred battery performance such as low resistance can be obtained.

### Positive Electrode Layer

The positive electrode layer 3 includes a positive electrode active material layer 31 and a positive electrode current collector layer 32. In the present embodiment, the positive electrode layer 3 has a configuration in which two positive electrode active material layers 31 are respectively laminated on both surfaces of one positive electrode current collector layer 32. On the other hand, the positive electrode layer 3 is not limited to this configuration, but may have a configuration in which one positive electrode active material layer 31 is laminated on one surface of one positive electrode current collector layer 32.

Each positive electrode active material layer 31 may be constituted by a material that can be used as a positive electrode active material of a solid-state battery, without any particular limitation. Examples of the positive electrode active material constituting each positive electrode active material layer 31 include layered positive electrode active material particles such as LiCoO₂, LiNiO₂, LiCoₓNi_{y}Mn_{z}O₂ (x+y+z=1), LiVO₂, LiCrO₂, etc., a spinel type positive electrode active material such as LiMn₂O₄, Li(Ni_{0.25}Mn_{0.75})₂O₄, LiCoMnO₄, Li₂NiMn₃O₈, etc., an olivine type positive electrode active material such as LiCoPO₄, LiMnPO₄, LiFePO₄, etc., a solid solution oxide (Li₂MnO₃—LiMO₂ (M=Co, Ni, etc.)), a conductive polymer such as polyaniline, polypyrrole, etc., a sulfide such as Li₂S, CuS, Li—Cu—S compounds, TiS₂, FeS, MoS₂, a Li—Mo—S compound, etc., a mixture of sulfur and carbon, and the like. One kind of the foregoing positive electrode active materials may be used alone, or two or more of kinds thereof may be used in combination.

An insulating frame 6 may be provided along the outer periphery of each positive electrode active material layer 31. The insulating frame 6 can prevent or reduce short-circuiting in the solid-state battery 1 and increase strength of the solid-state battery 1. In the present embodiment, the insulating frames 6 are disposed so as to cover the side surfaces of the two positive electrode active material layers 31 formed on both surfaces of the positive electrode current collector layer 32. Each insulating frame 6 is in contact with a part of the lamination surface of the positive electrode current collector layer 32 and has a gap through which a positive electrode current collector tab 32a described later extends. Each insulating frame 6 may be constituted by any material, and examples thereof include an insulating oxide such as alumina, etc., a resin such as polyvinylidene fluoride (PVDF), etc., and rubber such as styrene-butadiene rubber (SBR) etc., and the like.

The positive electrode current collector layer 32 may be constituted by any material, example thereof include aluminum, stainless steel, conductive carbon (graphite, carbon nanotubes, etc.), and the like. Examples of the shape of the positive electrode current collector layer 32 include a foil shape, a plate shape, a mesh shape, a nonwoven fabric shape, a foamed shape, etc. A part of the positive electrode current collector layer 32 extends in a predetermined direction to form the positive electrode current collector tab 32a.

### Method of Manufacturing Solid-State Battery

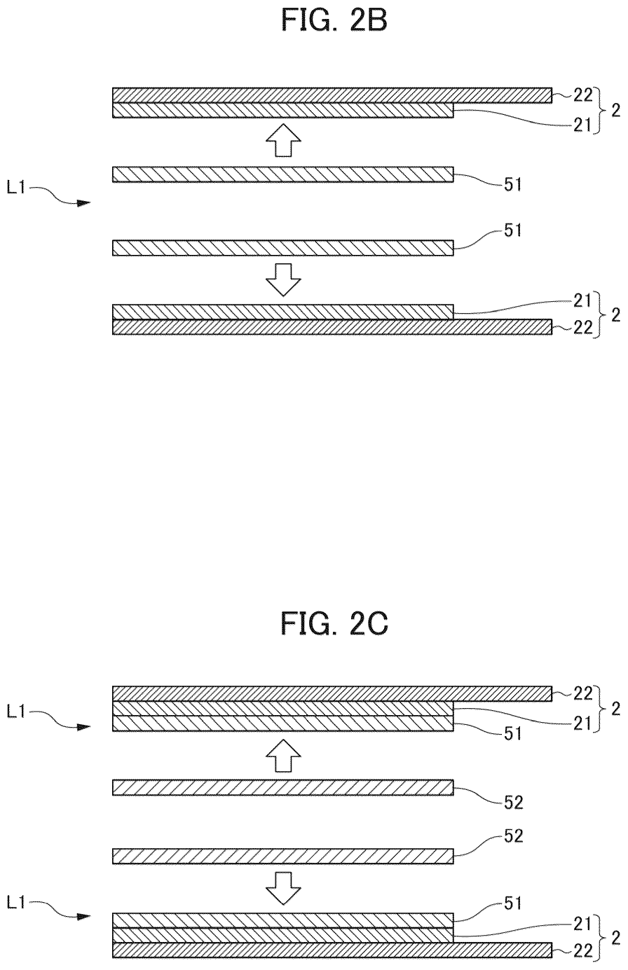

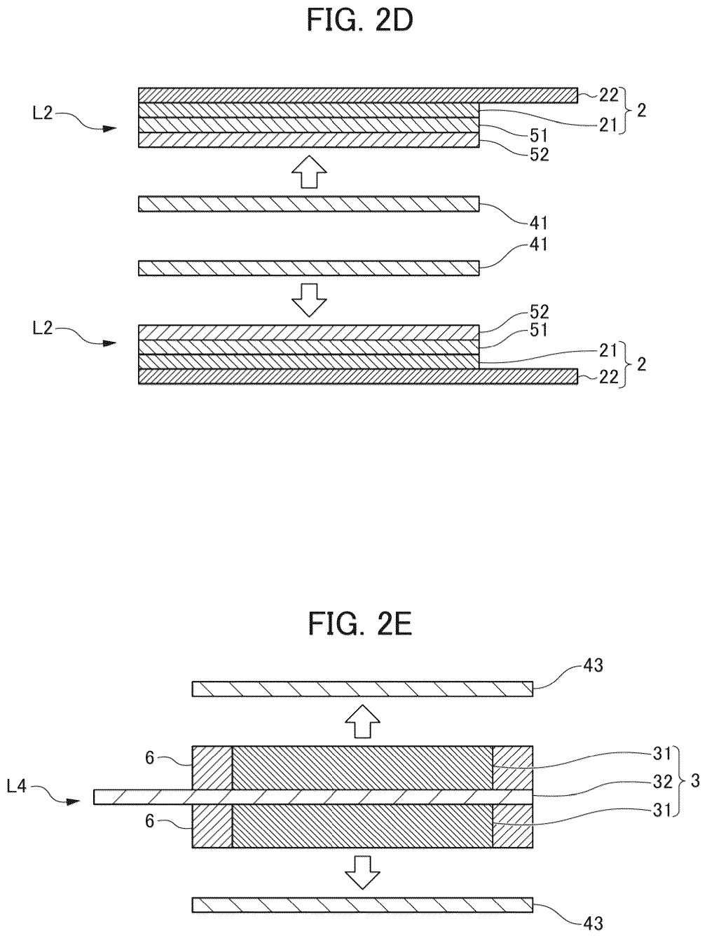

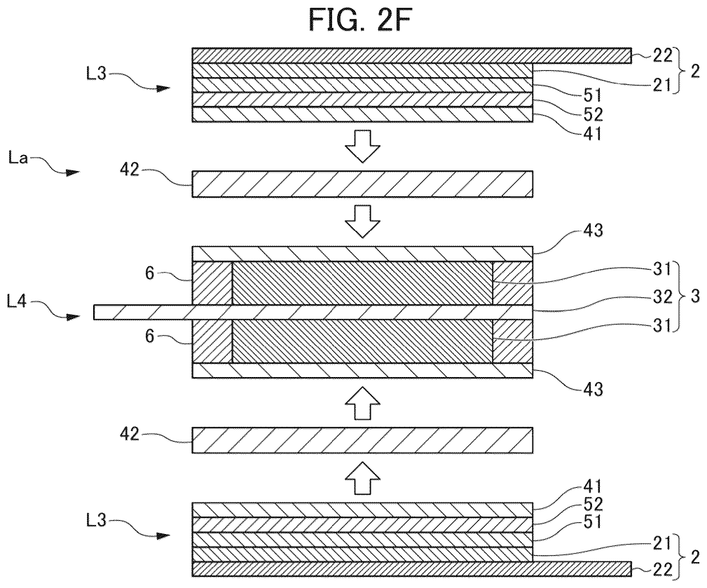

A method of manufacturing a solid-state battery according to the present embodiment will be described below with reference to FIGS. 2A to 2F. The method of manufacturing a solid-state battery according to the present embodiment is adapted for manufacturing a solid-state battery that includes an electrode laminate La in which a negative electrode layer 2, an intermediate layer (including a first intermediate layer 51 and a second intermediate layer 52), a solid electrolyte layer 4, and a positive electrode layer 3 are laminated in this order.

The method of manufacturing a solid-state battery according to the present embodiment includes, as essential steps: a first step of press-bonding the negative electrode layer 2 and the first intermediate layer 51 thereby obtaining a first intermediate layer-negative electrode layer laminate L1; a second step of press-bonding the first intermediate layer-negative electrode layer laminate L1 and the second intermediate layer 52 thereby obtaining an intermediate layer-negative electrode layer laminate L2; and a third step of disposing and press-bonding a substance that constitutes a solid electrolyte layer (first solid electrolyte layer 41) onto a lamination surface of the intermediate layer (second intermediate layer 52) of the intermediate layer-negative electrode layer laminate L2, thereby obtaining a solid electrolyte layer-intermediate layer-negative electrode layer laminate L3. The pressing temperature in each pressing step may be set to room temperature (approximately 25° C.).

As illustrated in FIG. 2B, the first step includes disposing and press-bonding the first intermediate layer 51 onto a surface of the negative electrode active material layer 21 of the negative electrode layer 2. Specifically, the first intermediate layer 51 may be disposed on the surface of the negative electrode active material layer 21 by being transferred by means of an intermediate layer transfer sheet. The intermediate layer transfer sheet is obtained, for example, by applying a slurry prepared by dispersing a material for constituting the first intermediate layer 51 in a solvent to a support sheet, and drying the slurry.

In the first step, the negative electrode layer 2 and the first intermediate layer 51 can be pressed at any pressing pressure as long as the negative electrode layer 2 and the intermediate layer 5 can be bonded to each other such that these layers are not excessively deformed and will not be peeled off in a later step. The pressing pressure in the first step is, for example, within the range of 300 MPa or greater.

As illustrated in FIG. 2C, the second step includes disposing and press-bonding the second intermediate layer 52 onto a surface of the first intermediate layer 51 of the first intermediate layer-negative electrode layer laminate L1. The second intermediate layer 52 formed into a sheet shape in advance can be used in this step.

In the second step, the first intermediate layer-negative electrode layer laminate L1 and the second intermediate layer 52 is pressed at a pressure within the range of 300 MPa or greater and 600 MPa or less, for example.

As illustrated in FIG. 2A, the method of manufacturing a solid-state battery according to the present embodiment preferably includes a first-A step of pressing the second intermediate layer 52 before the second step. Pressing and densifying the second intermediate layer 52 in advance in the first-A step allow the second intermediate layer 52 to have a porosity within a preferred range, and makes it possible to reduce the likelihood of the formation of dendrites. For example, as illustrated in FIG. 2A, the first-A step can be performed by pressing the second intermediate layer 52 formed on a support sheet S. The second intermediate layer 52 may be peeled off from the support sheet S after the first-A step, or the support sheet S may be peeled off from the laminate obtained by way of the second step. The first-A step may be carried out at any timing as long as the first-A step precedes the second step.

In the first-A step, the second intermediate layer 52 is preferably pressed at a pressing pressure higher than the pressing pressure in the first step and the pressing pressure in the second step. This allows the second intermediate layer 52 to be densified. The pressing pressure in the first-A step is, for example, within the range of 600 MPa or greater and 1200 MPa or less. The pressing in the first-A step is preferably performed at room temperature or higher and 100° C. or lower. The room temperature means, for example, 25° C. Setting the pressing temperature within the above range makes it possible to suitably densify the intermediate layer.

As illustrated in FIG. 2D, the third step includes disposing and press-bonding the solid electrolyte layer onto a surface of the second intermediate layer 52 of the intermediate layer-negative electrode layer laminates L2. Although FIG. 2D illustrates, as the solid electrolyte layer, the first solid electrolyte layer 41, which forms part of the solid electrolyte layer 4 having a three-layer structure, the solid electrolyte layer may have a single layer structure. In a case where the solid electrolyte layer 4 having a three-layer structure is used, it is preferable to press-bond the first solid electrolyte layer 41 (i.e., one of the three solid electrolyte layers) in the third step. The solid electrolyte layer may be disposed by using a solid electrolyte transfer sheet similar to the intermediate layer transfer sheet, or using a solid electrolyte sheet prepared by forming the solid electrolyte into a sheet shape in advance.

In the third step, the intermediate layer-negative electrode layer laminate L2 and the solid electrolyte layer is preferably pressed at a pressure higher than the pressing pressure in the first step and the pressing pressure in the second step. This allows the solid electrolyte layer to be densified. The pressing pressure in the third step is, for example, within the range of 500 MPa or greater and 800 MPa or less.

As illustrated in FIG. 2F, the method of manufacturing a solid-state battery according to the present embodiment preferably includes a fourth step of press-bonding the solid electrolyte layer-intermediate layer-negative electrode layer laminate L3 and a layer including at least the positive electrode layer 3, thereby obtaining the electrode laminate La. In the drawings, the layer including at least the positive electrode layer 3 is a solid electrolyte layer-positive electrode layer laminate L4 in which the positive electrode layer 3 and the third solid electrolyte layer 43 are laminated, but this is non-limiting example.

The fourth step preferably includes disposing a second solid electrolyte layer 42 between the solid electrolyte layer-intermediate layer-negative electrode layer laminate L3 and the solid electrolyte layer-positive electrode layer laminate L4 such that the second solid electrolyte layer 42 faces the solid electrolyte layers, and press-bonding the laminates together to obtain the electrode laminate La. The second solid electrolyte layer 42 formed into a sheet shape in advance may be used in this step. In the present embodiment, the solid electrolyte layer-positive electrode layer laminate L4 has the third solid electrolyte layers 43 respectively provided on both surfaces thereof. Therefore, two second solid electrolyte layers 42 are disposed so as to respectively face both surfaces of the solid electrolyte layer-positive electrode layer laminate L4, and further, two solid electrolyte layer-intermediate layer-negative electrode layer laminates L3 are disposed to sandwich therebetween the two second solid electrolyte layers 42 and the solid electrolyte layer-positive electrode layer laminate L4. In a case where the solid electrolyte layer-positive electrode layer laminate L4 has the third solid electrolyte layer 43 only on one surface, one second solid electrolyte layer 42 can be disposed so as to face the third solid electrolyte layer 43, and one solid electrolyte layer-intermediate layer-negative electrode layer laminate L3 can be further disposed.

The fourth step is for integrating the layers described above, and therefore, it is preferable to set the pressing pressure to such a level at which the layers are not excessively deformed. From this viewpoint, the pressing pressure in the fourth step is preferably higher than the pressing pressures in the first step and the pressing pressures in the second step and lower than the pressing pressure in the third step. The pressing pressure in the fourth step is set within the range of 500 MPa or greater and 900 MPa or less, for example.

As illustrated in FIG. 2E, the method of manufacturing a solid-state battery according to the present embodiment preferably includes a third-A step of pressing the layer including the positive electrode layer 3 before the fourth step. For example, as illustrated in FIG. 2E, the third-A step includes disposing and press-bonding a substance for constituting the third solid electrolyte layer 43 onto a lamination surfaces of the positive electrode layer 3, thereby obtaining the solid electrolyte layer-positive electrode layer laminate L4. The third-A step is not limited to this, but may include pressing only the positive electrode layer 3. In the present embodiment, the positive electrode layer 3 includes the positive electrode current collector layer 32 and the positive electrode active material layers 31 formed on both surfaces of the positive electrode current collector layer 32, and the third solid electrolyte layers 43 are disposed on both of the positive electrode active material layers 31. In a case where the positive electrode active material layer 31 is formed on only one surface of the positive electrode current collector layer 32 of the positive electrode layer 3, the third solid electrolyte layer 43 can be disposed on the one positive electrode active material layer 31. The third solid electrolyte layers 43 may be disposed in a way similar to that in the third step.

In the third-A step, the layer including the positive electrode layer 3 is preferably pressed at a pressure higher than the pressing pressure in the fourth step in which the layers are integrated. Such a pressure allows the layer including the positive electrode layer 3 to be densified. The pressing pressure in the third-A step is within the range of 700 MPa or grater and 1200 MPa or less, for example.

In each of the above-described steps, the press-bonding may be performed by any apparatus, and example thereof include a roll press apparatus and a plate press apparatus. In a case where the press-bonding is performed by a roll press apparatus, the components to be press-bonded may be conveyed to the roll press apparatus in the same direction or different directions. For example, the direction in which the components are conveyed to the roll press apparatus in the third step and the third-A step may be different from or orthogonal to the direction in which the components are conveyed to the roll press apparatus in the fourth step. As a result, among the layers, a layer having a low Young's modulus is extended in one direction, whereby the solid electrolyte layer 4 is pulled, and defects are less likely to occur in the solid electrolyte layer 4.

It should be noted that the present invention is not limited to the preferred embodiments described above. The solid-state battery 1 may include a component that can be used for a solid-state battery, such as an exterior jacket and the like, in addition to the electrode laminate illustrated in FIG. 1. The method of manufacturing a solid-state battery may include any optional steps in addition to the steps described above.

### EXPLANATION OF REFERENCE NUMERALS

1: Solid-state battery
2: Negative electrode layer
3: Positive electrode layer
4: Solid electrolyte layer
41: First solid electrolyte layer
42: Second solid electrolyte layer
43: Third solid electrolyte layer
51: First intermediate layer
52: Second intermediate layer
L1: First intermediate layer-negative electrode layer laminate
L2: Intermediate layer-negative electrode layer laminate
L3: Solid electrolyte layer-intermediate layer-negative electrode layer laminate
La: Electrode laminate

What is claimed is:

1. A method of manufacturing a solid-state battery that includes an electrode laminate in which a negative electrode layer, an intermediate layer, a solid electrolyte layer, and a positive electrode layer are laminated in this order,
the intermediate layer including a first intermediate layer and a second intermediate layer,
the method comprising:
press-bonding the negative electrode layer and the first intermediate layer, thereby obtaining a first intermediate layer-negative electrode layer laminate;
press-bonding the first intermediate layer-negative electrode layer laminate and the second intermediate layer, thereby obtaining an intermediate layer-negative electrode layer laminate; and
disposing and press-bonding a substance that constitutes the solid electrolyte layer onto a lamination surface of the intermediate layer of the intermediate layer-negative electrode layer laminate, thereby obtaining a solid electrolyte layer-intermediate layer-negative electrode layer laminate.

2. The method according to claim 1, further comprising:
pressing the second intermediate layer, before the press-bonding the first intermediate layer-negative electrode layer laminate and the second intermediate layer, wherein
a pressing pressure in the pressing the second intermediate layer is higher than a pressing pressure in the press-bonding the negative electrode layer and the first intermediate layer and a pressing pressure in the press-bonding the first intermediate layer-negative electrode layer laminate and the second intermediate layer.

3. The method according to claim 1, wherein
a pressing pressure in the disposing and press-bonding the substance that constitutes the solid electrolyte layer onto the lamination surface of the intermediate layer of the intermediate layer-negative electrode layer laminate is higher than a pressing pressure in the press-bonding the negative electrode layer and the first intermediate layer and a pressing pressure in the press-bonding the first intermediate layer-negative electrode layer laminate and the second intermediate layer.

4. The method according to claim 1, further comprising:
press-bonding the solid electrolyte layer-intermediate layer-negative electrode layer laminate and a layer including at least the positive electrode layer, thereby obtaining an electrode laminate, wherein
a pressing pressure in the press-bonding the solid electrolyte layer-intermediate layer-negative electrode layer laminate and the layer including at least the positive electrode layer is higher than a pressing pressure in the press-bonding the negative electrode layer and the first intermediate layer and a pressing pressure in the press-bonding the first intermediate layer-negative electrode layer laminate and the second intermediate layer.

5. The method according to claim 4, wherein
the pressing pressure in the press-bonding the solid electrolyte layer-intermediate layer-negative electrode layer laminate and the layer including at least the positive electrode layer is lower than a pressing pressure in the disposing and press-bonding the substance that constitutes the solid electrolyte layer onto the lamination surface of the intermediate layer of the intermediate layer-negative electrode layer laminate.

6. The method according to claim 4, further comprising:
pressing the layer including at least the positive electrode layer, before the press-bonding the solid electrolyte layer-intermediate layer-negative electrode layer laminate and the layer including at least the positive electrode layer, wherein
a pressing pressure in the pressing the layer including at least the positive electrode layer is higher than the pressing pressure in the press-bonding the solid electrolyte layer-intermediate layer-negative electrode layer laminate and the layer including at least the positive electrode layer.

7. The method according to claim 4, wherein
the solid electrolyte layer-intermediate layer-negative electrode layer laminate includes the solid electrolyte layer as a first solid electrolyte layer, and
the press-bonding the solid electrolyte layer-intermediate layer-negative electrode layer laminate and the layer including at least the positive electrode layer comprises:
disposing a second solid electrolyte layer between the solid electrolyte layer-intermediate layer-negative electrode layer laminate and the layer including at least the positive electrode layer; and press-bonding the second solid electrolyte layer, the solid electrolyte layer-intermediate layer-negative electrode layer laminate, and the layer including at least the positive electrode layer, thereby obtaining an electrode laminate.

8. The method according to claim 7, wherein
the press-bonding the solid electrolyte layer-intermediate layer-negative electrode layer laminate and the layer including at least the positive electrode layer comprises press-bonding the solid electrolyte layer-intermediate layer-negative electrode layer laminate including the solid electrolyte layer as the first solid electrolyte layer, and a solid electrolyte layer-positive electrode layer laminate including the positive electrode layer and a third solid electrolyte layer, thereby obtaining an electrode laminate.

9. The method according to claim 1, wherein
the layers are press-bonded such that the second intermediate layer has a porosity of 40% to 45%.

10. The method according to claim 1, wherein
the layers are press-bonded such that the first intermediate layer has a porosity equal to or greater than that of the second intermediate layer, and the porosity of the first intermediate layer is less than 50%.

11. The method according to claim 1, wherein
a pressing pressure in the press-bonding the negative electrode layer and the first intermediate layer is 300 MPa or greater,
a pressing pressure in the press-bonding the first intermediate layer-negative electrode layer laminate and the second intermediate layer is 300 MPa or greater and 600 MPa or less, and
a pressing pressure in the disposing and press-bonding the substance that constitutes the solid electrolyte layer onto the lamination surface of the intermediate layer of the intermediate layer-negative electrode layer laminate is 500 MPa or greater and 800 MPa or less.

12. The method according to claim 2, wherein
the pressing pressure in the pressing the second intermediate layer is 600 MPa or greater and 1200 MPa or less.

13. The method according to claim 4, wherein
the pressing pressure in the press-bonding the solid electrolyte layer-intermediate layer-negative electrode layer laminate and the layer including at least the positive electrode layer is 500 MPa or greater and 900 MPa or less.

14. The method according to claim 2, wherein
the pressing the second intermediate layer is performed at room temperature or higher and 100° C. or lower.
